(19) United States
(12) Patent Application Publication
(10) Pub. No.: US 2023/0303445 A1
(43) Pub. Date: Sep. 28, 2023

(54) CARBONATABLE COMPOSITIONS, METHODS AND USES OF SAME FOR ADDITIVE MANUFACTURE

(71) Applicant: Solidia Technologies, Inc., San Antonio, TX (US)

(72) Inventors: Amitabha KUMAR, San Antonio, TX (US); Padmaja PARAKALA, San Antonio, TX (US); Frederic DUNAND, Columbus, MS (US); Russell L. HILL, San Antonio, TX (US)

(21) Appl. No.: 18/204,045

(22) Filed: May 31, 2023

Related U.S. Application Data
(60) Provisional application No. 63/347,839, filed on Jun. 1, 2022.

(51) Int. Cl. C04B 28/12; C04B 40/02; C04B 24/04; B33Y 40/20

(52) U.S. Cl. CPC C04B 28/12; C04B 40/0231; C04B 24/04; B33Y 40/20; C04B 2111/00172

(57) ABSTRACT

A method of forming a cured cement or concrete object is described that includes printing a carbonatable material and a CO₂ source; and hardening the printed carbonatable material by a carbonation reaction. Associated cured and uncured objects, as well as related methods are also described.

The present application claims priority to and the benefit of U.S. Provisional Application No. 63/347,839 filed on Jun. 1, 2023, the entire contents of which are incorporated herein by reference.

### FIELD

The present application is directed to carbonatable compositions, methods and uses of the same for additive manufacturing, such as 3-D printing.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

The production of ordinary Portland cement (OPC) is a very energy-intensive process and a major contributor to greenhouse gas emissions. The cement sector is the third largest industrial energy consumer and the second largest CO₂ emitter of total industrial CO₂ emissions. World cement production reached 4.1 Gt in 2019 and is estimated to contribute about 8% of total anthropogenic CO₂ emissions.

In an attempt to combat climate change, the members of the United Nations Framework Convention on Climate Change (UNFCC), through the Paris Agreement adopted in December 2015, agreed to reduce CO₂ emissions by 20% to 25% in 2030. This represents an annual reduction of 1 giga ton CO₂. Under this agreement, the UNFCC agreed to keep the global temperature rise within 2° C. by the end of this century. To achieve this goal, the World Business Council for Sustainable Development (WBCSD) Cement Sustainability Initiative (CSI) developed a roadmap called “Low-Carbon Transition in Cement Industry” (WBCSD-CSI). This roadmap identified four carbon emissions reduction levers for the global cement industry. The first lever is improving energy efficiency by retrofitting existing facilities to improve energy performance. The second is switching to alternative fuels that are less carbon intensive. For example, biomass and waste materials can be used in cement kilns to offset the consumption of carbon-intensive fossil fuels. Third is reduction of clinker factor or the clinker to cement ratio. Lastly, the WBCSD-CSI suggests using emerging and innovative technologies such as integrating carbon capture into the cement manufacturing process.

Thus, there is a need for improved cement production that reduces CO₂ emissions; and, therefore, reduces the global effect of climate change. The present disclosure attempts to address these problems, as identified by the EPA and the UNFCCC, by developing a method of integrating carbon capture into the cement manufacturing process.

For instance, Solidia Technologies Inc. has developed a low CO₂ emissions clinker that reduces the CO₂ emissions by 30%. However, a need exists to integrate such materials into applications that may otherwise make use of conventional hydraulic concrete materials, and to further boost the positive environmental potential through the use of such low CO₂ emissions materials

The conventional method of making a concrete structure or object by mixing hydraulic cement with sand and water to create a slurry followed, by curing, is slow, labor-intensive and costly. While 3D printing can improve efficiency in the construction industry, formulating a suitable cementitious material that remains freestanding while curing, without the need for additional support material and can bind quickly while being printed, remains challenging.

### SUMMARY

It has been discovered that the above-noted deficiencies can be addressed, and certain advantages attained, by the present invention. For example, the methods, and compositions of the present invention provide 3-D printable carbonatable compositions with key features like improved workability, handleability, and superior strength. These compositions can be used without additional support material during the curing step. These compositions have the ability to cure quickly without the need for an intervening bonding layer.

Such compositions do not require curing accelerators, which favor a rapid hardening (in terms of setting and compressive strength development) of a cementitious binder, and do not require drying chambers due to instantaneous curing, hardening, and strength development while being printed. This invention relates to novel carbonation cured formulations and in particular, to methods of making the compositions with an optimum balance between printability, strength and workability. The compositions of the present invention serve to reduce the clinker factor of conventional hydraulic cements and concretes, and incorporate carbon capture into both the production and curing of the conventional hydraulic cement or concrete material, thus providing a doubly positive environmental benefit.

The approach involves the use of carbonatable cements that are well suited for additive manufacturing, that is forming an object by the application of a number of layers added sequentially, that would allow fast printing of both traditional and non-traditional shapes. This invention overcomes prior art shortcomings by accelerating the curing process through an acid base reaction, wherein the cementing action is caused by the reaction of a CO₂ bearing acid, such as a carboxylate or carbonic acid, and a base such as calcium hydroxide, calcium silicate, or similar material. The physical strength is developed through carbonation, in comparison to carbon intensive 3D printed Portland cement-based products, where strength is developed through hydration mechanisms.

Traditional 3-D cement or concrete printing methods involve printing out a slurry or a dry cement powder and then spraying it with water to cause the structure to harden. By contrast, the present invention overcomes the shortcomings of these conventional techniques by using a powdered cementitious material that is capable of being hardened through reactions involving carbonation. The powdered cementitious material of the present invention can be delivered as an aqueous or non-aqueous (without water) paste, with or without a chemical as an integral or secondarily applied stream, such as carbonic acid, or a carboxylate, or a specific chemical specie that can harden the cementitious material in a certain time span. A major benefit of this method is that it creates a finished structure in record time due to immediate strength development. Optionally, the additional application of water can be avoided, thus speeding deployment. The curing mechanisms of the compositions of the present invention is more complex and precise than those created using hydraulic reactions.

According to certain aspects there is provided a method of forming a cured cement or concrete object, the method including: printing a carbonatable material and a CO₂ source; and hardening the printed carbonatable material by a carbonation reaction.

According to further aspects, there is provided a method of forming a cured cement or concrete object, the method including: printing a first layer comprising a carbonatable material and a CO₂ source; hardening the printed first carbonatable material by a carbonation reaction, thus forming a hardened first layer; printing a second layer comprising the carbonatable material and the CO₂ source onto the first hardened layer; and hardening the printed second carbonatable material by a carbonation reaction, thus forming a hardened second layer.

It should be understood that the various individual aspects and features of the present invention described herein can be combined with any one or more individual aspect or feature, in any number, to form embodiments of the present invention that are specifically contemplated and encompassed by the present invention. This includes any combination of the various features recited in the claims, regardless of their stated dependencies.

### BRIEF DESCRIPTION OF THE DRAWINGS

These and other features of this invention will now be described with reference to the drawing which is intended to illustrate and not to limit the invention.

FIG. 1 is a schematic illustration of nozzle print head associated with application of the compositions according to one aspect of the present invention, and associated methods, according to certain exemplary embodiments.

FIG. 2 is a bottom view of the nozzle of FIG. 1.

FIG. 3 is a schematic illustration of nozzle print head associated with application of the compositions according to one aspect of the present invention, and associated methods, according to certain exemplary embodiments.

FIG. 4 is a bottom view of the nozzle of FIG. 3.

### DETAILED DESCRIPTION

Further aspects, features and advantages of this invention will become apparent from the detailed description which follows.

As used herein, the singular forms “a”, “an” and “the” are intended to include the plural forms as well, unless the context clearly indicates otherwise. Additionally, the use of “or” is intended to include “and/or”, unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of a composition or composite material, or other properties and characteristics. All of the values characterized by the above-described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the endpoints of the range. As an example, a variable which is described as having values between 0 and 10, can be 0, 4, 2-6, 2.75, 3.19-4.47, etc.

In the specification and claims, the singular forms include plural referents unless the context clearly dictates otherwise. As used herein, unless specifically indicated otherwise, the word “or” is used in the inclusive sense of “and/or” and not the exclusive sense of “either/or.”

Technical and scientific terms used herein have the meaning commonly understood by one of skill in the art to which the present description pertains, unless otherwise defined. Reference is made herein to various methodologies and materials known to those of skill in the art.

Unless a specific methodology provided, the various properties and characteristics disclosed herein are measured according to conventional techniques familiar to those skilled in the art.

According to the present invention, one possibility is to use a finely divided powdered carbonatable cement composition as a carbonatable binding agent such as powdered monocalcium silicate. Examples of which can include wollastonite or pseudowollastonite, or minerals such as rankinite, or belite. The powder could be classified by passing it through 200 mesh, or 325 mesh, or 400 mesh, or 600 mesh, or 1000 mesh, or 1250 mesh or 2000 mesh. The median particle size could be anywhere from 0.2 μm to 200 μm. The minimum size could be from 0.001 μm to 200 μm. The maximum size could be from 0.1 μm to 1000 μm. The powdered material may be mixed with an aqueous medium, such as distilled water, deionized water, tap water, brackish water, potable water, acidified water, or carbonated water, to form a paste of suitable consistency. The powdered material may be mixed with a non-aqueous medium such as an oil, a deep eutectic solvent or some other liquid, to provide suitable viscosity characteristic for pumping, delivery and/or printing.

In one embodiment, the printable composition is applied as two separate streams; where one stream is the printable cement, and the other stream is the carbon dioxide source. Alternatively, the printable composition is applied as or as single stream composed of both the printable cement and the carbon dioxide source, that are mixed for a relatively short time prior to the printing step. Additional operations may include heating and or cooling and/or evacuation to promote hardening as needed, where temperatures may range from sub-ambient to over 500° C. and pressures range from near vacuum to 10 bars.

The powdered carbonatable paste is to be exposed to the material that has the ability to carbonate and cure or harden the material. The carbonation reaction is designed to be performed at a suitable rate to allow for 3D printing. Thus, the curing or hardening may be in <1 second up to 2 hours depending on the next steps necessary. The 3D printing may be done in small quantities or in large quantities, depending on the needs of the process.

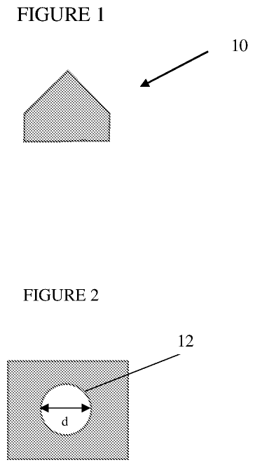

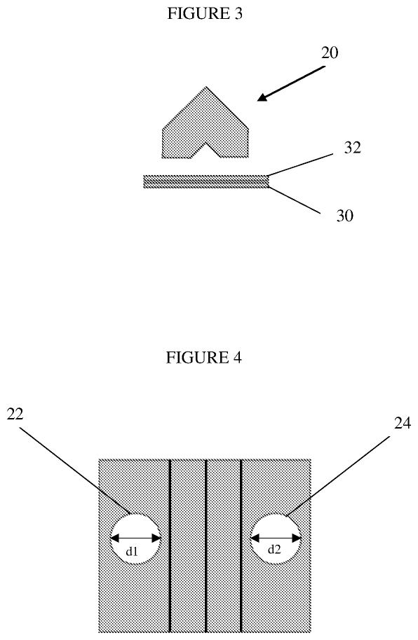

As illustrated in FIGS. 1-2, in one embodiment, the paste may be ejected through a nozzle 10, the nozzle 10 having an opening 12 with a diameter d from 5 μm to 50 mm size, and the carbonating medium being applied to or mixed into the material ejected from the nozzle 10. As illustrated in FIGS. 3-4, according to one alternative, the nozzle may be in the form of dual-headed nozzle 20 with two openings 22, 24 with diameters d1, d2 sized as described above. The carbonatable cement paste being ejected through one of the openings, and the carbonating medium being ejected through the other opening in the nozzle 20. Alternatively, as noted previously, the nozzle may be in the form of a single-headed nozzle 10 with a single opening, whereby a mixture of the carbonatable cement paste and carbonating medium are ejected as a single stream.

According to certain embodiments, the carbonation reaction can proceed quickly, in the range of <10 minutes from a “plastic” state to a hardened state, or <5 minutes, or <1 minute, or <30 seconds, or <10 seconds or <1 second.

In yet another embodiment, reinforcement can be placed in the injected material prior to hardening, or as illustrated schematically in FIG. 3, the hardened material 30 is placed in a manner during the injection process to create spaces that can be used to place reinforcement 32. The spaces with reinforcement may be seated and cemented in place with additional cement (not shown). The order of the materials illustrated in FIG. 3 may also be reversed, or the arrangement further modified.

The fibrous additions could be: mesh, woven strands, chopped fiber, individual strands, strands could be few μm to >40 mm diameter. Material of fiber could be steel, glass, basalt, polypropylene, nylon, polycarbonate, coated steel, coated glass, coating could be organic such as acrylic, resin, paint, metal coating, ceramic coating graphene, carbon nanotubes, graphite.

If the carbonatable cement paste and carbonating medium are mixed prior to ejection, then the time for hardening is sufficient to allow for proper mixing of the two substances. If the carbonatable cement paste and carbonating medium are ejected as two separate streams, then the cementitious material is ejected in amounts that can be reacted sufficiently to provide required hardening due to reaction with the second stream without the requirement of heated print beds.

The speed of the carbonation reaction can be controlled by adjusting the carbonating agent/cement ratio, acid strength, buffers and additives. The reaction can be made to occur quickly using acid and base carbonating agents, or slowly, depending on the materials used. Carbonating agent materials may include quaternary ammonium salts and carboxylic acids, such as choline chloride in a deep eutectic solvent (DES), or choline chloride and lactic acid, or carboxylates such as acetic acid, or an AHA such as lactic acid. DES functions as the liquid solvent in the mixture and the reaction time can be varied to a desired timeframe. The formulations can be optimized to provide the right amount of liquid phase to the mixture while the reaction rates can be adjusted to meet printability speed.

The concrete composition capable of use in a printing process comprises a solid mixture of coarse aggregate, fine aggregate, and a carbonatable binding agent, wherein the solid material proportions are chosen to provide a printable and compactable mixture with density ranging from 500 to 3,000 kg/m³ and strength when carbonated of at least 500 psi. The dry mixture may be combined with an aqueous or non-aqueous phase with the resulting mixture having a viscosity ranging from 20 Pa to 500 Pa at 0.2 revolutions per minute that hardens to viscosity greater than 5,000 Pa after being exposed to a carbonation source such as a gas, or liquid, or solid, containing CO₂ or a species capable of providing carbon and oxygen for carbonation. The resulting mixture may further comprise additional components such as viscosity modifying agents, flow control admixtures, plasticizer admixtures, shrinkage compensation and shrinkage reducing admixtures, and/or fibrous additions that provide flexural strength of 100 to over 12,000 psi.

The carbonatable binder-based composite is adjustable in terms of strength and toughness, thus controlling the versatility of the printed material. The advantages of employing an additive, layer-based, manufacturing technique for carbonatable cements through a chemical reaction include ease in fabrication and curing, reduced water usage and waste, accuracy and efficiency for varying construction components, lowering the cost for installation, and/or fast deployment in crisis zones cross the globe.

In view of the above, it will be seen that the several advantages of the invention are achieved, and other advantages attained.

As various changes could be made in the above methods and compositions without departing from the scope of the invention, it is intended that all matter contained in the above description shall be interpreted as illustrative and not in a limiting sense.

Any numbers expressing quantities of ingredients, constituents, reaction conditions, and so forth used in the specification are to be interpreted as encompassing the exact numerical values identified herein, as well as being modified in all instances by the term “about.” Notwithstanding that the numerical ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. § 112, paragraph 6, unless the term “means” is explicitly used.

We claim:

1. A method of forming a cured cement or concrete object, the method comprising:
printing a carbonatable material and a CO₂ source; and
hardening the printed carbonatable material by a carbonation reaction.

2. The method of claim 1, wherein the printing comprises ejecting the carbonatable material and the CO₂ source through a nozzle.

3. The method of claim 2, wherein the carbonatable material and the CO₂ source are ejected as separate streams.

4. The method of claim 2, wherein the carbonatable material and the CO₂ source are mixed, then ejected as a single stream.

5. The method of claim 1, wherein the CO₂ source comprises a carboxylate or carbonic acid, and calcium hydroxide or calcium silicate.

6. The method of claim 1, wherein the carbonatable material comprises a dry mixture of coarse aggregate, fine aggregate, and a carbonatable binding agent.

7. The method of claim 6, wherein the dry mixture is combined with an aqueous or non-aqueous liquid phase, and the resulting mixture is in the form of an aqueous or non-aqueous paste having a viscosity ranging from 20 Pa to 500 Pa at 0.2 revolutions per minute.

8. The method of claim 1, wherein the amount of coarse aggregate, fine aggregate, and a carbonatable binding agent in the dry mixture are chosen to provide a printable and compactable mixture with density ranging from 500 to 3,000 kg/m³ and strength when carbonated of at least 500 psi.

9. The method of claim 6, wherein the carbonatable binding agent is in the form of a finely divided powder having a median particle size of 0.2 μm to 200 μm, a minimum particle size of 0.001 μm to 200 μm, and a maximum particle size of 0.1 μm to 1000 μm.

10. The method of claim 1, wherein the hardening is performed for <1 second to 2 hours.

11. The method of claim 1, wherein the carbonatable material comprises at least one of wollastonite, pseudowollastonite, rankinite, or belite.

12. The method of claim 1, wherein the carbonatable material further comprises a reinforcement.

13. The method of claim 1, wherein the printing comprises printing a mixture of aggregate and the carbonatable material.

14. The method of claim 11, wherein the mixture has a density of 500 to 3000 kg/m³.

15. The method of claim 11, wherein the mixture has a viscosity of 20 Pa to 500 Pa.

16. The method of claim 1, wherein the carbonation reaction sequesters CO₂ within the hardened material.

17. The method of forming a cured cement or concrete object of claim 1, the method further comprising:
printing a first layer comprising the carbonatable material and the CO₂ source;
hardening the printed first carbonatable material by the carbonation reaction, thus forming a hardened first layer;
printing a second layer comprising the carbonatable material and the CO₂ source onto the first hardened layer; and
hardening the printed second carbonatable material by the carbonation reaction, thus forming a hardened second layer.
